(19) United States
(12) Patent Application Publication
(10) Pub. No.: US 2016/0364708 A1
(43) Pub. Date: Dec. 15, 2016

(54) PAY TO PLAY REVERSE AUCTION BIDDING SYSTEM

(71) Applicant: MonsterQuote, Inc., San Francisco, CA (US)

(72) Inventor: Jerrill Evan Rice, Flower Mound, TX (US)

(21) Appl. No.: 14/737,305

(22) Filed: Jun. 11, 2015

(51) Int. Cl. G06Q 20/14; G06Q 50/00; G06Q 30/08

(52) U.S. Cl. CPC G06Q 20/145; G06Q 30/08; G06Q 50/01

(57) ABSTRACT

The present application includes a system and method for providing a buyer the ability to submit a single request for bidding from multiple contractors. The system includes program software to network the buyer with multiple bidders, social media, dealer partners, retail centers, and a housing database. The contractors are placed in a reverse auction bidding process where each contractor pays a bidding fee at the time of placing a bid. The fee is in proportion to the size of the bid. Fees are collected from each bidder and the cumulative fee is distributed to the system owner and shared with the dealer partner if used. Social media allows the buyer to see friends who have used the system and upload/download pictures of work done by others in the area.

### BACKGROUND

1. Field of the Invention

The present application relates generally to an online reverse auction system, and in particular to a method of obtaining a plurality of quotes from bidders for construction jobs at a residence or business location.

2. Description of Related Art

The home building sector is responsible for hundreds of millions of dollars in business and revenue each year. This includes work performed for new home builds and for remodels on existing homes. The remodel and new home business typically revolves around a relationship between three parties: a homebuyer/homeowner, a dealer, and a contractor. Typically a homebuyer/homeowner may go through a dealer to select upgrades and materials or decide to contact contractors directly. The interaction within these relationships fail to provide the homebuyer/homeowner with the best price. A new system is needed to modify these relationships to correct for the many disadvantages currently seen.

Dealers often have a specific contractor they work through. Dealers can be design centers from a new home builder or those located at home improvement stores, even stand-alone locations. Generally, the dealer acts as a middle man between the contractor and the homebuyer/homeowner. A disadvantage to the homebuyer/homeowner is that Dealers make money off of the service they provide by marking up the work of the contractor. Not only does the homebuyer/homeowner have limited contractor selection, but they pay extra for the services they purchase. The three party relationship further includes a disadvantage for the dealer as well. The dealer is typically tasked with the liability for the work performed by the contractor. The inflated fee helps to offset some of the risk from the liability of the dealer.

A resistance from modifying these relationships is the desire for the dealer and the contractor to make a profit. Dealers provide contractors with a ready set of business. Therefore the need to advertise may be diminished by the contractor. However, contractors still need to advertise. This is typically done by sending out flyers. A cost is incurred through the labor and the materials. It is not unheard of that advertising only have a minimal return for the cost of advertising. This only strengthens the desire to maintain the current link with dealers. Dealers like to have trusted contractors to use that they can trust and have provided an approved rate for their labor. Dealers want to be the middle man between the contractor and the homebuyer/homeowner in order to make money.

This relationship model typically only provides dealers with about 10% of the work available. The other 90% of the work is sourced between the homebuyer/homeowner and the contractors directly. This relationship has its disadvantages as well. Typically the homebuyer/homeowner has very limited access to suitable or “qualified” contractors in which to obtain a bid. They may be left getting bids from contractors unqualified or not very reputable. Additionally, contractors typically bid through a blind process where they don't know of the other bids being made. The homebuyer/homeowner is left to sort through and select the best one. This means that the price for the work is not necessarily at its lowest point.

It is desired that a system be developed to permit a change in the relationship described above. The system and method being designed to allow for better pricing and maintaining the profit for the dealer and the contractor. Although great strides have been made, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is chart of a reverse auction bidding system according to the preferred embodiment of the present application;

FIG. 2 is an exemplary schematic of the system of FIG. 1 for providing a platform for handling a reverse auction bidding process between a plurality of bidders so as to achieve the lowest competitive price from reputable and qualified labor;

FIG. 3 is a detailed chart showing the interaction of a dealer, a buyer, and the bidder in the system of FIG. 1;

FIG. 4 is a method of receiving a bid for a job requested through the system of FIG. 1;

FIG. 5 is a timeline providing context with respect to time duration for the reverse auction bidding process in the system of FIG. 1; and

FIG. 6 is an example of the fee distribution using the system of FIG. 1.

While the assembly and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method in accordance with the present application overcomes one or more of the above-discussed problems commonly associated with conventional bidding methods. The system and method of receiving a bid for a job request according to the present application is configured to place the homebuyer/homeowner in contact with a pool of potential qualified contractors and engage the contractors in a reverse bidding process to produce the lowest or best price for the homebuyer/homeowner. The system and method collects fees from the bidders upon submission of a bid (pay-to-play process). The fees are distributed to the system owner and possibly the dealer, if used. The dealer acts as a consultant to the homebuyer/homeowner and is optionally used depending on the situation. The system and method has the homebuyer/homeowner make a deposit to compensate the winning bidders if the homebuyer/homeowner fails to proceed with the job. These and other unique features of the system and method are discussed below and illustrated in the accompanying drawings.

The system and method will be understood, both as to its structure and operation, from the accompanying drawings, taken in conjunction with the accompanying description. Several embodiments of the assembly are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The system includes one or more electronic devices in communication through a network that provide selective access and capability to multiple interested parties, such as a homebuyer/homeowner, one or more contractors/bidders, retail stores, dealers, a home database, and social network sites. The system includes programmable software to permit functional interfaces for use by each interested party. The programmable software is processed and executed through the one or more electronic devices. Each interested party has certain rites and capabilities within the system. The method includes a series of steps interacting these parties with one another to permit a homebuyer/homeowner a competitive price with good quality contractors by placing the contractors in a reverse auction process.

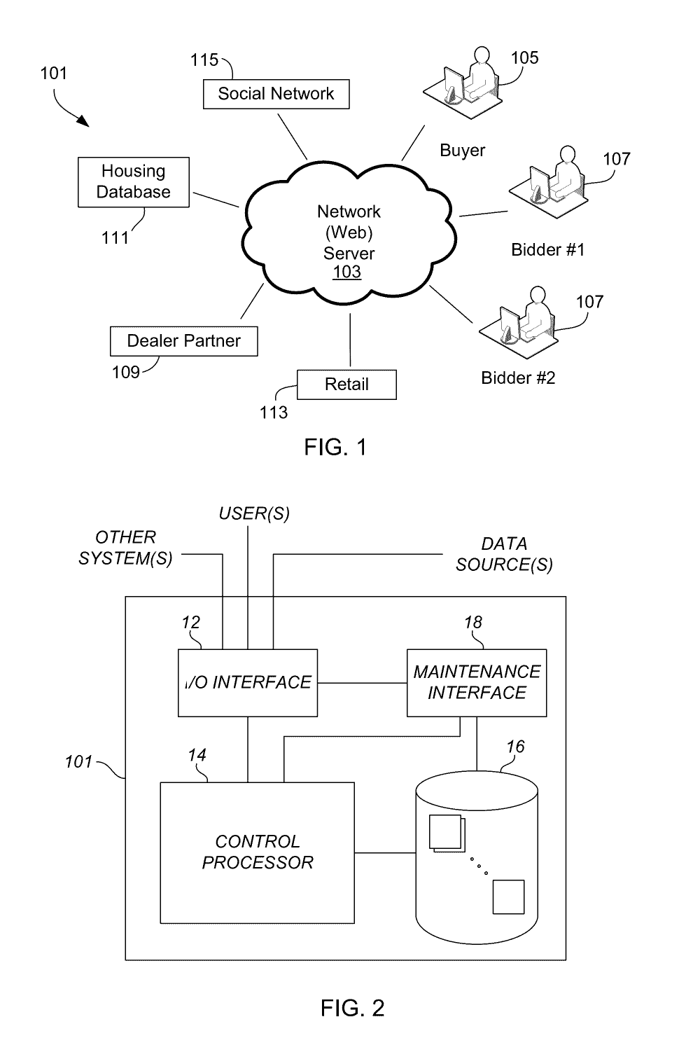

Referring now to the drawings wherein like reference characters identify corresponding or similar elements in form and function throughout the several views. FIG. 1 illustrates the system of the present application with a number of interested parties. System 101 is configured to provide a suitable platform (programmable software) for handling a reverse auction process involving a number of interested parties. The parties use system 101 to interact over a network via the internet. The network of computers includes a server 103 within system 101 that hosts or manages the reverse auction process. The auction system includes the one or more computers and the associated software providing a plurality of web pages capable of being displayed on any of the individual computerized devices using a conventional browser program. The different interested parties interact through the system 101, over the network, to elicit bids, job requests, recommendations, and information. System 101 is engaged by a buyer 105, one or more bidders 107, and an optional dealer partner 109. System 101 may further include interaction with a housing database 111, retail suppliers 113, and social networks 115. System 101 is configured to provide buyer 105 the ability to receive a competitive quote from one or more bidders 107 by subjecting bidders 107 to a reverse auction system where each bidder 107 is ranked according to one or more bidder characteristics. Each bidder is charged a bidding fee at the time the bid is submitted (pay-to-play).

Referring now also to FIG. 2 in the drawings, an exemplary schematic of system 101 for providing a platform for handling a reverse auction bidding process between a plurality of bidders so as to achieve the lowest competitive price from reputable and qualified labor is illustrated. Buyers 105 review and formulate a request for work through one or more web pages via system 101. Bidders 107 access system 101 through a series of web pages to view and selectively bid on a job request from buyer 105. System 101 also obtains bidding fees from each bidder at the time of placement of the bid. The fees are selectively distributed to the owner of system 101 and potentially to dealer 109. System 101 includes program software executed on one or more computerized devices. FIG. 2 illustrates exemplary computerized devices configured to execute and access the programs associated with system 101. System 101 includes the hardware (as described herein) and the program software to perform the functions described in this application. Server 103 and any of the computerized devices associated with parties 105, 107, 109, 111, 113, and 115 are described below.

The system 101 includes an input/output (I/O) interface 12, a control processor 14, a database 16, and a maintenance interface 18. Alternative embodiments can combine or distribute the input/output (I/O) interface 12, control processor 14, database 16, and maintenance interface 18 as desired. Embodiments of the system 101 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore the computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the system 101. The I/O interface 12 is in communication with the control processor 14 and database 16 and is configured to provide an interactive link between the buyer and other interested parties. The I/O interface 12 can be configured for allowing one or more users to input information to the system 101 via any known input device. Examples can include a keyboard, mouse, touch screen, microphone, and/or any other desired input device. The I/O interface 12 provides a display portal defining a plurality of visually perceptible elements corresponding to the prediction data. The I/O interface 12 can be configured for allowing one or more users to receive information output from the system 101 via any known output device. Examples can include a display monitor, a printer, a speaker, and/or any other desired output device. The I/O interface 12 can be configured for allowing other systems to communicate with the system 101. For example, the I/O interface 12 can allow one or more remote computer(s) to access information, input information, and/or remotely instruct the system 101 to perform one or more of the tasks described herein. The I/O interface 12 can be configured for allowing communication with one or more remote data sources. For example, the I/O interface 12 can allow one or more remote data source(s) to access information, input information, and/or remotely instruct the system 101 to perform one or more of the tasks described herein.

The database 16 provides persistent data storage (computer readable storage media, i.e. hardware) for system 101. Database 16 is in communication with control processor 14 and I/O interface 12. While the term “database” is primarily used, a memory or other suitable data storage arrangement may provide the functionality of the database 16. In alternative embodiments, the database 16 can be integral to or separate from the system 101 and can operate on one or more computers. The database 16 preferably provides non-volatile data storage for any information suitable to support the operation of the system 101, including various types of data necessary to perform the functions and feature discussed below.

The maintenance interface 18 is configured to allow users to maintain desired operation of the system 101. In some embodiments, the maintenance interface 18 can be configured to allow for reviewing and/or revising the data stored in the database 16 and/or performing any suitable administrative tasks commonly associated with database management. This can include, for example, updating database management software, revising security settings, and/or performing data backup operations. In some embodiments, the maintenance interface 18 can be configured to allow for maintenance of the control processor 14 and/or the I/O interface 12. This can include, for example, software updates and/or administrative tasks such as security management and/or adjustment of certain tolerance settings.

The control processor 14 can be configured to perform a process or a plurality of processes such as the processes described below in connection with the associated Figures. Additionally, control processor 14 includes software programmed to compile properly communicate with the interested parties. Processor 14 includes a non-transitory computer-readable medium with instructions stored thereon to execute predetermined steps. Various functions of the control processor 14 may be realized, such as uploading and downloading of visual data, compilation and submission of requests, compilation and submission of bids, interaction with social media, determining the rank of each bidder, and tracking the financial payments to the proper parties, and so forth.

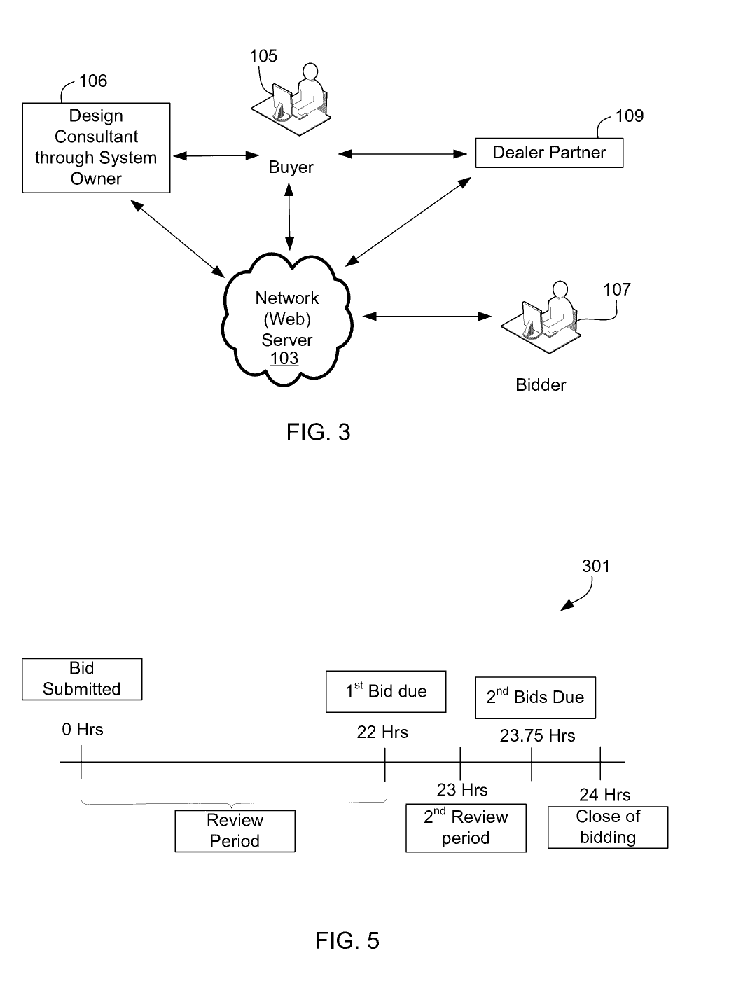

Referring now also to FIG. 3 in the drawings, a detailed chart of the interaction of buyer 105, dealer 109, and contractor 107 within system 101 is illustrated. Buyer 105 is either a new home buyer, an existing home owner, or business representative. Buyer 105 arrives at the point where upgrades, renovations, improvements or repairs are needing to be done to a home or structure. Buyer 105 has the option of using system 101 in one of three ways: 1) use system 101 directly to prepare and submit a request for a quote; 2) work with dealer partner 109; and 3) request the assistance of a design consultant from the system owner of system 101 to help buyer 105 in the preparation and submission of a request for a quote.

In the first option, Buyer 105 interacts directly with system 101 via server 103 and, through a series of questions, determines the type of service necessary and/or prepares and submits a request for a quote (RFQ). This option is useful for buyers that are knowledgeable and have the necessary information already for the RFQ. In some instances a buyer will try and have a contractor give them a quote but then desire more quotes looking for a better deal. System 101 is configured to permit buyer 105 to upload an existing quote from a contractor into system 101 in order to generate the RFQ. System 101 may include filtration processes wherein an employee of the system owner/system 101 may review the uploaded quote for accuracy and detail prior to posting it for bidding. It is an object of system 101 to ensure that buyers 105 are able to use system 101 in a diverse number of ways while maintaining the quality of the bids and RFQs.

In the second option, buyer 105 has to option of consulting with dealer partner 109 in order to gain advice, see options, and in general receive consultation regarding available options. Dealer partner 109 may be any of a design center associated with a new home builder for selecting upgrades on a new home, a design center within a large retailer location for use with existing homes, or a separate architectural or design business. Use of dealer partner 109 is optional by buyer 105. Buyer 105 may log into system 101 and create an RFQ on behalf of buyer 105. This allows dealer 109 to monitor the progress and make additional changes before or after bidding is completed if the project requires further services. This helps to alleviate any worry or time constraints of buyer 105.

In the third option, buyer 105 may seek the assistance of a design consultant from system 101. The design consultant 106 may be an employee or contractor of the system owner and system 101. Consultant 106 represents the system owner and is used to provide personal guidance for buyer 105. The consultation may include an in-home visit, communication over the phone only, or even guidance to help buyer 105 navigate system 101 to generate a RFQ. Consultant 106 may prepare and submit the RFQ or merely serve as a resource to assist buyer 105. An example of how consultant 106 may be used is where a buyer 105 is unsure of the information to put in the RFQ. Consultant 106 may be requested and visit the home to take measurements and obtain the necessary information to put into the RFQ to prepare it for submission. In this way, a single visit provides multiple quotes from various contractors 107. This is different from the method of having each contractor needing to visit to provide information. A fee may be charged for the use of consultant 106. System 101 may keep that fee regardless of the outcome of the RFQ. Alternatively, system 101 may reimburse buyer 105 the cost of the RFQ if buyer 105 accepts one of the bids. Use of the initial consultation fee is to help ensure good quality RFQs and therefore bids.

Payments collected via system 101 are passed through and automatically distributed in accordance with defined parameters. Bidding fees collected where dealer 109 is not involved are passed directly to the owner of system 101. Fees collected where dealer 109 is involved are split according to a fee division rate between the owner of system 101 and dealer 109. This fee compensates dealer 109 for their consultation services. Keep in mind that the total fee collected is based on the individual bidding fee from each bid of each bidder contractor 107. Therefore the total fee received by dealer 109 may actually be greater than that received via legacy methods.

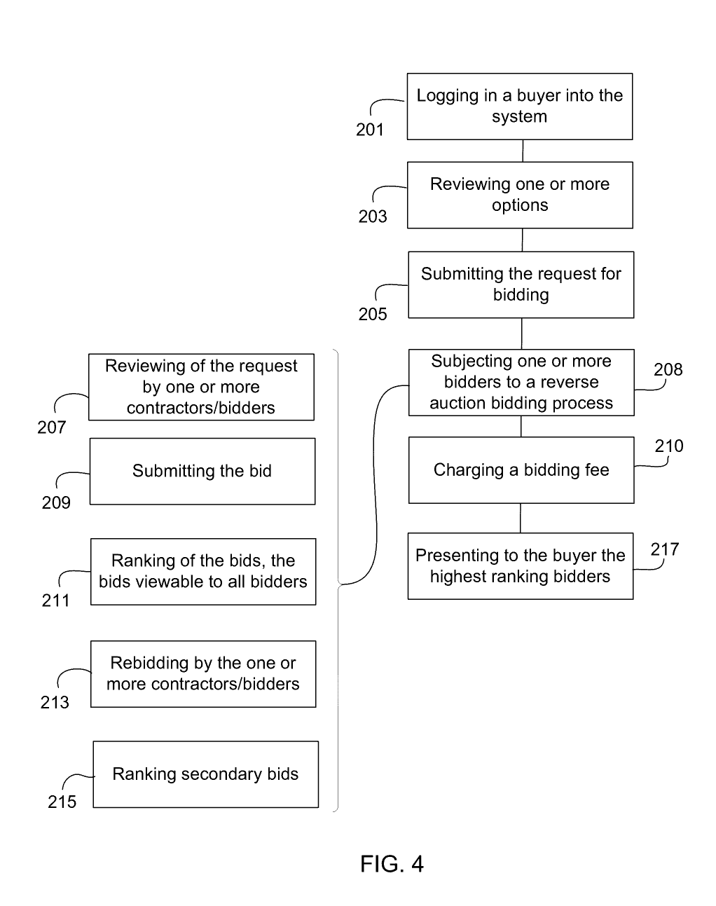

Referring now also to FIG. 4 in the drawings, the method of receiving a bid for a job request (i.e. RFQ) through system 101 is illustrated. Buyer 105 and/or dealer 109 log into the system 201 through a designated portal or web page. The system being connected via the network to one or more of the interested parties as noted in FIG. 1. The buyer and potentially the dealer partner review one or more options 203 through system 101 for incorporation into the home or structure of buyer 105. During this process, buyer 105 may consult and review with social media sites 115 to view friends that have used system 101. The buyer 105/dealer 109 prepare and submit a request for a job to be performed 205, which then begins the reverse auction bidding process.

Once the necessary decisions have been made, the reverse auction bidding process begins. A reverse auction refers to a process in which the buyer states requirements for a job that are viewable by one or more contractors who can elect to place a bid on the job. The bidders then compete by offering the lowest price, quickest delivery, or other conditions important to the buyer. The bids are viewable to each bidder after each round of bidding closes. The “reverse” term refers to the fact that as series of rounds occur, the competitive factor typically is adjusted more in favor of the buyer, such as price. Bidders or contractors may then view the bid 207 through the system. The contractor/bidder may then elect to submit a bid on the job requested 209. Notifications of new requests for jobs may be sent to registered contractors notifying them as bids come through to ensure a prompt reply.

Once the bidding time has ended, the system then ranks the bids according to a series of bidder characteristics and selection criteria 211. Each bid received within the designated time frame is processed by the system and assigned a ranking value. Each bid is available to other bidders for viewing. Time is allotted to the bidders to submit a secondary bid thereby creating the competitive environment. Those taking part in the secondary bidding process are re-ranked 215. Multiple rounds may occur. At the end of each bidding window, the list of ranked bidders is decreased by some percentage. For example, with the first bids maybe only the top 75% of bids are accepted and visible. After the secondary bid is made, the system may only accept the remaining top 50% of bidders. In this way, the list of bidders continually diminishes. At the close of bidding, the buyer is provided with a list of the top and final bidders. The bidder's and the buyer's information is exchanged at this point. The act of decreasing the amount of accepted bidders after each round helps to ensure a timely end to the bidding process.

Referring now also to FIG. 5 in the drawings, a timeline 301 is illustrated to provide context to the reverse auction bidding process of step 208. Bids submitted during a given work day may be processed instantly by system 101 and become available for contractors 107 to view during the review period. However, for simplicity and in order to allow contractors the most time to review, system 101 may hold all submissions for requests until a particular time of day and then release all or a portion of them. Multiple release times may be made. Once released, each contractor 107 may receive a notification via electronic means and spend a predetermined time frame reviewing each of the requests.

Contractor/Bidder 107 may then select which if any to bid on. All bids are to be entered by the close of the review period. At which time system 101 processes each of the bids from each of bidders 107 and ranks the bids. System 101 may elect to show all bids or show only a portion of all bids. Bids may be dismissed based on any one of the bidder characteristics and their relation to the selection criteria from buyer 105. For example, buyer may make a selection criteria that he/she only wants those with a rating of 4 or higher. Therefore all bidders below 4 stars would be dismissed. System 101 may however decide to override buyer's 105 selection criteria limitations in order to provide buyer 105 with some bids in which to compare. The processing of the bids may take a span of time not equal to that of the time illustrated.

A second review period then opens where the bidders who were accepted by system 101 are allowed to view the other bids that were made and see how they ranked. At this time each remaining bidder 107 may submit a secondary bid by changing any one of the bid items that are key to buyer 105. For example, where buyer 105 makes price and time to completion a priority, bidder 107 may quote a lower price and/or shorter time to completion in order to increase its ranking.

After the second bids are due, system 101 reprocesses each of the remaining bids from each of the acceptable bidders 107. New rankings are produced and made viewable to the bidders 107. The rebidding process may occur for additional rounds if necessary. System 101 is configured to continually shrink the number of accepted bids each round. In other words, system 101 will take and keep an ever decreasing amount of the bidders each round. This helps to narrow down the available bidders to those most in line with the selection criteria of the buyer. It also helps bring to a close the bidding process in a reasonable time. It is important to note that system 101 encourages each bidder 107 to bring forth the best bid it can each round or else fear being rejected and dismissed. The reverse bidding process is configured to assist the buyer 105 by driving the price down, sorting through a pool of qualified and reputable contractors.

Once the bidding is completed, the top remaining bidders 107 are provided to buyer 105. At this time the business information of each bidder is revealed to buyer 105 and each top bidder is provided the contact information of the buyer 105. Buyer 105 may elect to contact one or more of the top bidders to proceed. Also, each bidder may elect to contact the buyer 105 to try and make a case for selecting them as the winner. In some embodiments the buyer is able to purchase bidder information related to any one of the one or more bidders that submitted a bid. This would involve payment of an additional fee and is expected to occur in the event that buyer 105 is not happy with any of the top bidders selected through system 101. After a bidder has been selected by the buyer, the buyer may use system 101 to provide feedback and rate the contractor. This rating is then applied to the contractor and processed by system 101, thereby affecting the overall rating of the contractor in the future.

It is understood that the time frames illustrated in FIG. 5 are illustrative only and are in no way limiting. The number of bidding rounds and the time frames may be modified.

A key feature of system 101 is the use of a dynamic/static pricing. To differentiate over legacy methods of requesting a job or bid, system 101 is configured to charge each bidder 107 a charge or bidding fee for the first bid. This fee goes to the owner of system 101. The fee will be split with dealer 109 as necessary according to a predetermined rate. In order to work with dealers 109, compensation for dealers 109 must be equal to or be greater than what it was receiving.

System 101 is designed to give increase the profits of dealer 109 and decrease the price for buyer 105. If pricing remains at inflated levels as contractors work directly with dealers, most buyers elect to forgo use of the dealers and navigate the process alone. By system 101 decreasing the cost to the buyers, dealers will increase the market share of the business. Profits for the dealers are maintained by the cumulative billing fee for each request (assuming more than one contractor bids).

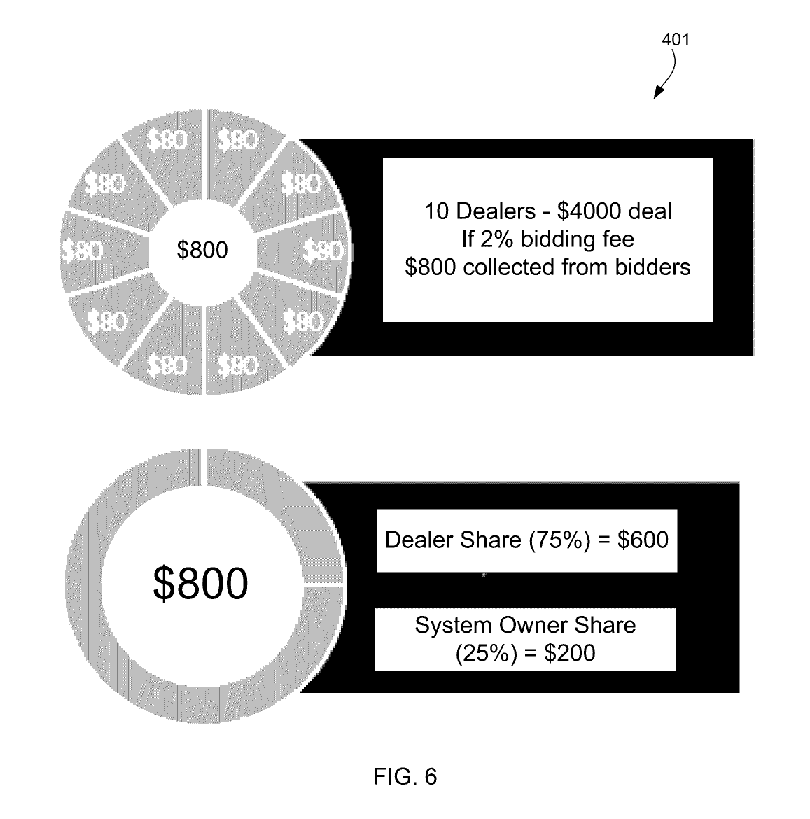

Referring now also to FIG. 6 in the drawings, a bidding fee example 401 used in system 101 is illustrated. In a situation where a request around the value of $4000 worth of work was made, and 10 contractors placed a bid, the billing fee would be collected from each contractor in relation to his/her bid. If the bidding fee was 2% of the bid price, around $800 would be collected. It is assumed that dealer 109 was used and is to receive a portion of the fee collected. If the fee is to be split at a 75/25 split in favor of dealer 109, dealer 109 is set to receive $600 and the owner of system 101 would receive $200.

In situations where dealers choose to directly hire contractors and retain the method of inflating prices (i.e. upwards of 40%), buyers will be less likely to use them resulting in less market share. In the example of FIG. 6, at 40% price inflation, a buyer would pay $5,600 and dealer 109 would receive $1,600. If the going rate of closure for new homes to have a buyer use the design center is only 30% then the dealer would expect to earn $4,800 out of 10 deals. However, if system 101 is used, and because of decrease prices to the buyer, the dealer now closes upwards of 80%, then it could be reasoned that system 101 would bring dealer 109 upwards of $4,800 as well out of 10 similar requests for work. System 101 is designed to increase the market conversion rate or market share for dealers 109 so as to make system 101 as profitable as legacy systems or methods.

It is understood that the bidding fee rate may be adjusted from that of 2%. Additionally the rate at which the collected billing fees are dispersed between the system owner and dealers 109 may be altered. The bidding fee may be assessed to bidders 107 in different ways. For example, the bidding fee may be set at a particular rate and shared amongst the total number of bidders. In this example, the bidders may not know the exact amount they will be charged until after all bidding has occurred. Another way to assess bidding fees is where the rate is fixed for each bidder. Thirdly, the bidding fee may be altered for particular types of projects within the same request or adjusted given the geographical area in which the buyer is located. System 101 collects the bidding fee from each bidder regardless of the performance of the bidder in the reverse auction bidding process or whether or not the buyer selects any of the system selected bidders.

To encourage a contractor to be selected, buyer 105 may be required to submit a deposit or down payment that is applied to the eventual services of the bidder. In situations where the buyer 105 backs out and fails to select a bidder, the deposit may be dispersed amongst the top bidders according to some predetermined method. The deposit acts to compensate bidders for their time and efforts.

An additional feature of system 101 is the ability to incorporate a loyalty program to buyers 105 and even bidders 107. System 101 is configured to assign a point value for each job completed or bid on. The point value being cumulative over a plurality of jobs and redeemable for value.

As noted previously, system 101 is configured to process and calculate a rating for each contractor (i.e. ratings of 1-5). The contractor ratings are based on an algorithm that incorporates a series of data and criteria to arrive at a singular rating. Examples of data and criteria used by system 101 are external ratings on customer review sites, government sites (i.e. Better Business Bureau), whether the contractor is licensed, any grievances or complaints, type and skill of employees, location, and years in business, for example. The ratings are visible to buyer 105 along with each contractor's business contact information. However during bidding, the business information and identity of the contractor bidding is withheld from buyer 105. Buyer 105 is permitted to use system 101 and enter a review for or against the winning contractor. This review influences the system rating of the contractor for good or bad in the future.

System 101 is also configured to permit any of the interested parties to upload visual data, such as pictures or video, related to products and before and after photographs. The visual data may be attached from any mobile device such as a phone, tablet, camera, and so forth. When uploaded onto system 101, the information is accessible by the public. This visual data may be searched and viewed by a potential buyer prior to placing a request for work. The visual data may be attached by buyers to insert into their requests as visual examples of the type of work they are seeking. Additionally a buyer may assign a preferential status (i.e. press a “like” button) and comment on each visual data placed in the request for work.

Another feature of system 101 is the optional integration of social media sites 115. Use of social media sites 115 makes the uploading and downloading of visual data simple. System 101 optionally communicates with one or more social media websites. Buyers may create an account on system 101 and log in via a social media website. An advantage of using a social media account is the ability system 101 has to connect work performed through system 101 of friends in the social media network. Buyer 105 may log in to system 101 and see if any social media friends have used system 101 and potentially the type of work performed. Other items that may be visible to friends are ratings, reviews, visual data, bids, and so forth. It is understood that each buyer/user may assign selected privacy levels that selectively restrict the amount of information made public. For example, a buyer may select to share nothing, information stating that they were a customer only, visual data, or the entire bid. Such information is visible in accordance with the selected privacy.

System 101 may also include housing database 111. Database 111 is configured to store, for retrieval, specifications, measurements, and information related to homes and structures. In particular, each home or structure includes a set of plans and blue prints for its construction. In new home build situations, database 111 may be amended to include the lot number, neighborhood info, builder and home type of the new home. Database 111 may be amended to include existing homes and structures as necessary. System 101 is configured to provide a buyer the ability to enter home details for use by the bidders 107 in the bidding process. The more accurate the information provided, the more accurate the bid.

In instances where homes are not already existing in database 111, system 101 is configured to store particular details of homes and structures as they are entered in for the purpose of requesting bids. System 101 is configured to ask the buyer a plurality of questions about the home during the request preparation stage. Questions relate to information, such as square footage, type of flooring, builder, number of rooms, number of baths, location of rooms, and so forth. System 101 compares the provided answers with existing homes in database 111 and matches any existing homes in database 111 with those of the present buyer.

Retail 113 is also included within system 101. Retail 101 refers to establish home centers or home repair stores. Such stores often provide materials and tools to contractors who bid using system 101. System 101 is configured to permit bidder 107 to compare pricing and selection at a retail home center during the review stage of the bidding process. Bidders may solicit bids from retail centers and gain the best possible price prior to placing a bid in the reverse auction bidding process. Additionally, buyers 105 may also solicit retail stores for materials and tools necessary to complete a task. This may be used best for general budgeting for a project. Likewise, it is worth noting that system 101 may be used by bidders to also seek quotes from sub-contractors prior to placing a bid. By integrating both sub-contractors and retail centers 113, system 101 is configured to provide the bidder 107 with the best possible opportunity to submit a satisfactory bid and compete on an even playing field.

The current application has many advantages over the prior art including at least the following: (1) reverse auction bidding process for contractors bidding on a project; (2) system allows the buyer to submit a specific request to generate multiple bids; (3) billing fee charged to a bidder at the time of submission of the bid; (4) removal of liability from the dealer partner for work done by a contractor; (5) split fees between the system owner and the dealer partner; (6) incorporation of sub-contract labor and retail stores; and (7) loyalty points awarded for use of the system.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A method of receiving a bid for a job request, comprising:
logging into a system coupled to a network in order to place the job request;
reviewing one or more options through the network;
submitting the job request for bid, the job request being visible to one or more bidders;
subjecting the one or more bidders to a reverse auction bidding process where the bids of each of the one or more bidders is viewable to the other bidders; and
charging a bidding fee to the bidder of each bid at the time the bid is made;
wherein the bids of the one or more bidders is ranked according to bidder characteristics and buyer selection criteria, the buyer selecting one of the ranked bidders to perform the job.

2. The method of claim 1, wherein the system is logged into at a dealer partner location.

3. The method of claim 1, wherein the user logs into the system on a portable electronic device.

4. The method of claim 1, further comprising:
the user reviewing a social media network to gather information of what jobs social connections have had performed, the system in communication with the social media network.

5. The method of claim 1, wherein the options available are particular to the type of home the user has, the user selecting the particular home from a housing database.

6. The method of claim 1, wherein the options available are based on a description of the home provided by the user.

7. The method of claim 1, further comprising:
comparing prices at a retail store by at least one of the user prior to submitting the job request and the one or more bidders prior to submitting the bid or the secondary bid.

8. The method of claim 1, wherein the bidding fee is shared amongst the total number of bidders.

9. The method of claim 1, wherein the bidding fee is a percentage of the total bid for each bidder.

10. The method of claim 1, wherein the bidding fee is split between the system and a dealer partner, the dealer partner being a third party to the buyer and the one or more bidders that acts to provide guidance and instruction to the buyer.

11. The method of claim 1, wherein the bidding fee is paid regardless of whether the buyer accepts one of the bids.

12. The method of claim 1, wherein the one or more bidders use the system to gather quotes from a retail provider prior to submitting a bid.

13. The method of claim 1, wherein the one or more bidders use the system to gather quotes from a sub-contractor prior to submitting a bid.

14. The method of claim 1, wherein the buyer is able to purchase bidder information related to any one of the one or more bidders that submitted a bid.

15. The method of claim 1, wherein the buyer logs into the system and provides feedback used to affect the rank of the bidder.

16. The method of claim 1, wherein the one or more bidders partake in a reverse auction configured to provide the buyer with the lowest cost bid.

17. The method of claim 1, wherein the buyer places a deposit through the system to protect the interests of the one or more bidders and to ensure a deal is made between the buyer and the one or more bidders.

18. The method of claim 1, wherein the reverse auction bidding process includes:
reviewing of the bid by the one or more bidders;
submitting the bid by each of the one or more bidders;
ranking of the bids, the system accepting a portion of the bids for viewing;
rebidding by the one or more bidders previously accepted for viewing, so as to generate one or more secondary bids; and
ranking the secondary bids, the system accepting a portion of the remaining bids to be viewable to the buyer.

19. The method of claim 1, wherein the system is configured to place the buyer in control of the bidding process by engaging the one or more bidders in a reverse auction process, the identities of the one or more bidders and the buyer being concealed from one another until the bidding is complete.

20. The method of claim 1, wherein the system is configured to include a loyalty program that assigns a point value for each job completed, the point value being cumulative over a plurality of jobs and redeemable for value through the system.
